(19) United States
(12) Patent Application Publication
(10) Pub. No.: US 2026/0181185 A1
(43) Pub. Date: Jun. 25, 2026

(54) DEEP LEARNING-BASED VIDEO COMPRESSION USING OPTIMIZED RATE-DISTORTION

(71) Applicant: NVIDIA Corporation, Santa Clara, CA (US)

(72) Inventors: Star Huang, Shanghai (CN); Ankitesh Kumar Singh, Sunnyvale, CA (US); Xinyu Gong, Shanghai (CN); Sangeun Han, Mountain View, CA (US); Ankur Saxena, San Jose, CA (US); Manindra Parhy, Fremont, CA (US)

(21) Appl. No.: 19/012,754

(22) Filed: Jan. 7, 2025

(30) Foreign Application Priority Data
Dec. 25, 2024 (CN) 202411929868.X

(51) Int. Cl. H04N 19/80; H04N 19/105; H04N 19/109; H04N 19/11; H04N 19/124; H04N 19/13; H04N 19/147; H04N 19/176; H04N 19/50; H04N 19/85

(52) U.S. Cl. CPC H04N 19/80; H04N 19/105; H04N 19/109; H04N 19/11; H04N 19/124; H04N 19/13; H04N 19/147; H04N 19/176; H04N 19/50; H04N 19/85

(57) ABSTRACT

Systems and methods for enhancing image blocks of a frame of a video to be compressed are provided. The systems and methods enhance the image blocks to improve compression of the video to be compressed. In at least one embodiment, systems and methods are provided for using a learned prefiltering network, trained using a joint loss function, to enhance video content to improve compression.

### CLAIM OF PRIORITY

This application claims the benefit of Chinese Patent Application No. 202411929868.X, titled “Deep Learning-Based Video Compression Using Optimized Rate-Distortion,” filed Dec. 25, 2024, the entire contents of which are incorporated herein by reference.

### FIELD

The present disclosure relates to video compression and, in particular, to video compression techniques that employ a trained neural network to enhance video content for improved compression.

### BACKGROUND

Video compression reduces the size of digital video files while simultaneously limiting distortion to maintain visual quality. In recent years, on-demand video playback and video streaming services have proliferated. Video content now accounts for more than 80% of all consumer Internet traffic—a number that is expected to increase over the following years. Bandwidth reduction achieved by video compression has therefore become crucial for reducing network traffic to satisfy consumer demand.

The video compression process typically begins by dividing a video into a sequence of frames (i.e., images) and dividing each frame into a plurality of smaller blocks. Algorithms identify both redundancies between different frames (to provide for temporal compression) and redundant data within individual frames (to provide for spatial compression). Once identified, temporal and spatial redundancies can be removed or simplified, enabling the remaining data to be efficiently encoded.

Many video compression techniques rely on both inter- and intra-frame prediction as a means to exploit temporal and spatial redundancies. In inter-frame prediction, a predictor estimates frame content based on a previous frame or frames, and a corrector determines a difference between the estimated frame content and the actual frame content, i.e., frame correction values. In intra-frame prediction, a predictor estimates pixels based on, e.g., neighboring pixels, and a corrector determines a difference between the estimated pixels and the actual pixel values, i.e., pixel correction values. Compression is achieved by encoding only the frame correction values (for inter-frame prediction) and pixel correction values (for intra-frame prediction). The original video can then be reconstructed by estimating frames and pixels in the same manner and then correcting them with decoded frame correction values and pixel correction values.

In order to improve inter- and intra-frame prediction, a prefiltering process can be implemented to smooth out minor differences between frames and reduce noise and high-frequency content—which can be difficult to predict and can interfere with motion estimation between frames. The result is reduced magnitude frame- and pixel correction values that can be more efficiently compressed—e.g., via standard entropy coding techniques. Furthermore, by reducing complexity in both spatial and temporal domains, prefiltering can improve the efficiency of prediction algorithms used during downstream compression, potentially leading to better overall compression ratios. However, excessive prefiltering can introduce distortion and decrease playback quality.

Due to the tradeoff between file size and visual quality, the strength of prefiltering and the level of compression need to be tailored to the intended application, the available network bandwidth, and/or the desired playback quality.

### BRIEF DESCRIPTION OF THE DRAWINGS

Systems and methods of the present disclosure are described herein below with reference to the attached drawing figures, wherein:

FIG. 1A provides a block diagram of a system for compressing video content that includes a prefiltering network for providing AI-enhanced candidate predicted image blocks;

FIG. 1B illustrates example macroblock partition modes that can be included in the combination of prediction parameters in accordance with which a candidate predicted image block can be predicted;

FIG. 1C is a flow diagram illustrating a process for selecting candidate predicted image block for use in a downstream encoding process;

FIG. 2 is a flow diagram illustrating a process for training a prefiltering network with a joint loss function to enhance candidate predicted image blocks for improving compression during a downstream encoding process;

FIG. 3A is a graph of compression results achieved by incorporating, into a video codec pipeline, different prefiltering networks;

FIG. 3B provides example predicted candidate image blocks and residuals corresponding to an example reference image block;

FIG. 4 illustrates an example parallel processing unit suitable for use in implementing some embodiments of the present disclosure;

FIG. 5A is a conceptual diagram of a processing system implemented using the PPU of FIG. 4, suitable for use in implementing some embodiments of the present disclosure;

FIG. 5B illustrates an exemplary system in which the various architecture and/or functionality of the various previous embodiments may be implemented;

FIG. 5C illustrates components of an exemplary system that can be used to train and utilize machine learning, in at least one embodiment; and

FIG. 6 illustrates an exemplary streaming system suitable for use in implementing some embodiments of the present disclosure.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implemented using large language models (LLMs), systems implemented using vision language models (VLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The present disclosure provides systems and methods for enhancing video content in a manner that provides for improved compression. According to a first aspect, the present disclosure provides a learned prefiltering network, trained using a joint loss function, for enhancing video content to improve compression during an encoding stage. According to a second aspect, the present disclosure provides systems and methods for training a prefiltering network, using a joint loss function, to enhance video content in a manner that improves compression in a downstream encoding stage. According to a third aspect, the present disclosure provides for a system for compressing video content.

In embodiments of the present disclosure, a novel learned prefiltering network, trained using a joint loss function, is provided for enhancing video content to improve compression during a downstream encoding process. The joint loss function includes both (i) a distortion component and (ii) a rate component, thereby allowing the prefiltering network to learn to balance the error from quantization (i.e., distortion) with improved bit rate. In at least one embodiment, the distortion component measures the difference between (a) (one or more) residuals computed for a predicted image block and a corresponding reference macroblock and (b) (one or more) reconstructed quantized residuals. In at least one embodiment, the rate component is a differentiable approximation of a number of bits required to transmit quantized residuals. The novel learned prefiltering network is trained via a process that randomly samples a quantization parameter used for quantizing residuals during the downstream encoding stage, thereby ensuring that, over a large number of training iterations, the prefiltering network learns to enhance predicted image blocks for low, intermediate, and high levels of compression.

According to an aspect of the present disclosure, a method for compressing a video is provided. The method includes generating, for a reference block of a frame of the video, a plurality of candidate predicted blocks, each candidate predicted block being predicted in accordance with a combination of prediction parameters. The method further includes enhancing the plurality of candidate predicted blocks to provide a plurality of enhanced candidate predicted blocks, selecting a predicted block from the plurality of candidate predicted blocks and the plurality of enhanced candidate predicted blocks, computing residuals using the selected predicted block and the reference block, and encoding the residuals in a codestream (e.g., encoded bitstream). The enhancing the plurality of candidate predicted blocks is performed by at least one prefiltering network trained to minimize a joint loss function that includes a distortion component and a rate component.

In at least one embodiment of the method, the rate component of the joint loss function is determined using a differentiable approximation of an entropy coding scheme. In at least one embodiment of the method, the entropy coding scheme is context-adaptive binary arithmetic coding (CABAC), and the differentiable approximation is a theoretical limit of a number of bits Qf=log(1+Q) required to transmit quantized residuals Q using the entropy coding scheme.

In at least one embodiment of the method, the distortion component of the joint loss function is determined, during at least one (e.g., each) training iteration, by comparing (i) one or more spatial domain residuals reconstructed from quantized residuals computed from an enhanced predicted training block and a reference training block and (ii) one or more spatial domain ground-truth residuals computed from the enhanced predicted training block and the reference training block. In at least one embodiment of the method, the distortion component of the joint loss function is the mean squared error (MSE) between the reconstructed residuals and the ground-truth residuals.

In at least one embodiment of the method, the at least one prefiltering network is a prefiltering network trained to minimize the joint loss function via a training process that comprises a plurality of training iterations, and wherein a quantization parameter is randomly selected for at least one (e.g., each) training iteration of the plurality of training iterations.

In at least one embodiment of the method, the at least one prefiltering network is a prefiltering network trained to minimize the joint loss function via a training process that comprises a plurality of training iterations. At least one (e.g., each) training iteration includes enhancing a predicted training block, computing training residuals using the enhanced predicted training block and a reference training block, quantizing the training residuals, and calculating, based on the quantized training residuals, a value of the joint loss function from a value of the distortion component and a value of the rate component. At least one (e.g., each) training iteration further includes computing, based on the calculated value of the joint loss function, gradients of the joint loss function with respect to parameters of the prefiltering network and updating the parameters of the prefiltering network based on the computed gradients.

In at least one embodiment of the method, the plurality of candidate predicted blocks are generated by an intra-frame predictor and an inter-frame predictor, and the at least one prefiltering network includes an intra-frame prefiltering network for enhancing candidate predicted blocks generated by the intra-frame predictor and an inter-frame prefiltering network for enhancing candidate predicted blocks generated by the inter-frame predictor, the at least one prefiltering network includes a single prefiltering network for enhancing candidate predicted blocks generated by the intra-frame predictor and candidate predicted blocks generated by the inter-frame predictor.

In at least one embodiment of the method, the combination of prediction parameters include one or more parameters specifying at least one of: a prediction mode, a partition mode, a coding mode, a skip mode, a reference frame selection, a chroma subsampling mode, and/or a strength of one or more filters.

According to an aspect of the present disclosure, a system for compressing a video is provided. The system includes processing circuitry configured to generate, for a reference block of a frame of the video, a plurality of candidate predicted blocks, each candidate predicted block being predicted in accordance with a combination of prediction parameters. The processing circuitry is further configured to enhance, via at least one prefiltering network, the plurality of candidate predicted blocks to provide a plurality of enhanced candidate predicted blocks, select a predicted block from the plurality of candidate predicted blocks and the plurality of enhanced candidate predicted blocks, compute residuals using the selected predicted block and the reference block, and encode the residuals in a codestream. The system additionally includes memory configured to store the reference block, the plurality of candidate predicted blocks, and the codestream.

In at least one embodiment of the system, the rate component of the joint loss function is determined using a differentiable approximation of an entropy coding scheme. In at least one embodiment of the system, the entropy coding scheme is context-adaptive binary arithmetic coding (CABAC), and the differentiable approximation is a theoretical limit of a number of bits Qf=log(1+Q) required to transmit quantized residuals Q using the entropy coding scheme.

In at least one embodiment of the system, the distortion component of the joint loss function is determined, during each of a plurality of training iterations, by comparing (i) one or more spatial domain residuals reconstructed from quantized residuals computed using an enhanced predicted training block and a reference training block, with (ii) one or more spatial domain ground-truth residuals computed using the enhanced predicted training block and the reference training block. In at least one embodiment of the system, the distortion component of the joint loss function is the mean squared error (MSE) between the reconstructed residuals and the ground-truth residuals.

In at least one embodiment of the system, the at least one prefiltering network is a prefiltering network trained to minimize the joint loss function via a training process that comprises a plurality of training iterations, and wherein a quantization parameter is randomly selected for each training iteration of the plurality of training iterations.

In at least one embodiment of the system, the at least one prefiltering network is a prefiltering network trained to minimize the joint loss function via a training process that comprises a plurality of training iterations. At least one (e.g., each) training iteration includes enhancing a predicted training block, computing, using the enhanced predicted training block and a reference training block, one or more training residuals, quantizing the one or more training residuals, and calculating, based on the one or more quantized training residuals, a value of the joint loss function from a value of the distortion component and a value of the rate component. At least one (e.g., each) training iteration additionally includes computing, based on the calculated value of the joint loss function, one or more gradients of the joint loss function with respect to one or more parameters of the prefiltering network, and updating the parameters of the prefiltering network based on the one or more computed gradients.

In at least one embodiment of the system, the processing circuitry comprises an intra-frame predictor and an inter-frame predictor for generating the plurality of candidate predicted blocks, and the at least one prefiltering network includes an intra-frame prefiltering network for enhancing candidate predicted blocks generated by the intra-frame predictor and an inter-frame prefiltering network for enhancing candidate predicted blocks generated by the inter-frame predictor, or the at least one prefiltering network includes a single prefiltering network for enhancing candidate predicted blocks generated by the intra-frame predictor and candidate predicted blocks generated by the inter-frame predictor.

In at least one embodiment of the system, the combination of prediction parameters include parameters specifying one or more of a prediction mode, a partition mode, a coding mode, a skip mode, a reference frame selection, a chroma subsampling mode, and a strength of one or more filters.

According to an aspect of the present disclosure, a non-transitory computer readable medium is provided having stored thereon executable instructions that, when executed by processing circuitry, causes the processing circuitry to perform the method according to the aforementioned aspect or any embodiment thereof.

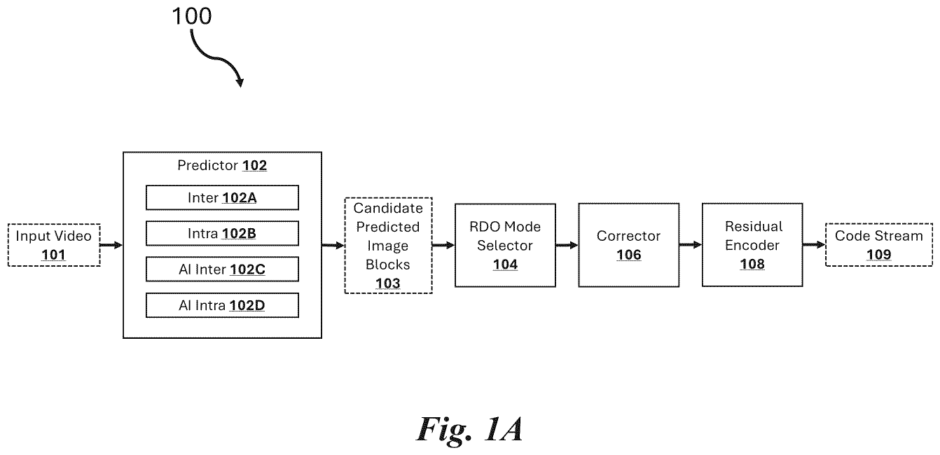

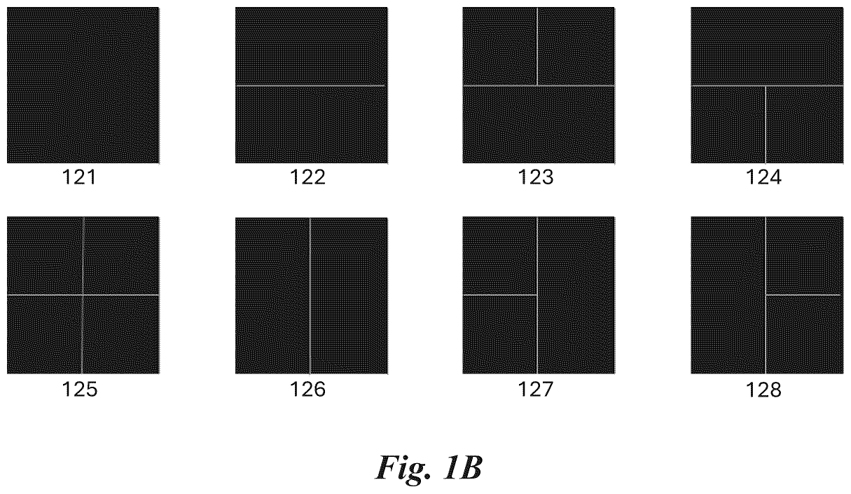

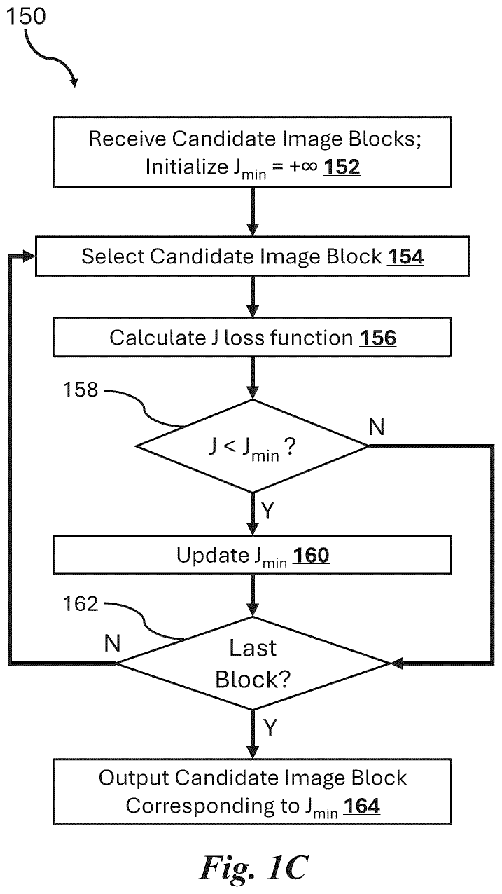

FIG. 1A provides a block diagram of a system 100 for compressing video content that includes a prefiltering network for providing AI-enhanced candidate predicted image blocks. The system 100 includes predictor 102, rate-distortion optimization (RDO) mode selector 104, predictor/corrector 106, and residual encoder 108.

Predictor 102 receives an input video 101 and performs processing of the input video 101 to produce candidate predicted image blocks 103. Predictor 102 divides each frame in the input video 101 into a plurality of macroblocks. The division is performed in accordance with an off-the-shelf video codec (e.g., H.264, HEVC, AV1, AV2, VVC, etc.). Predictor 102 further provides, for each respective macroblock, a plurality of candidate predicted image blocks for use in a downstream encoding process. At least one (e.g., each) of the plurality of candidate predicted image blocks is predicted in accordance with a unique combination of prediction parameters, which includes a prediction mode (i.e., intra-prediction or inter-prediction). For candidate predicted image blocks that specify the intra-prediction mode, additional specified prediction parameters can include, e.g., a macroblock partition mode and a directional mode. For candidate image blocks that specify the inter-prediction mode, one or more additional specified prediction parameters can include a macroblock partition mode, motion vector candidates, and reference frame indices. In at least one embodiment, at least one (e.g., each) macroblock partition mode is one of the macroblock partition modes illustrated in FIG. 1B. The candidate predicted image blocks are output as candidate predicted image blocks 103 and provided as input to the RDO mode selector 104.

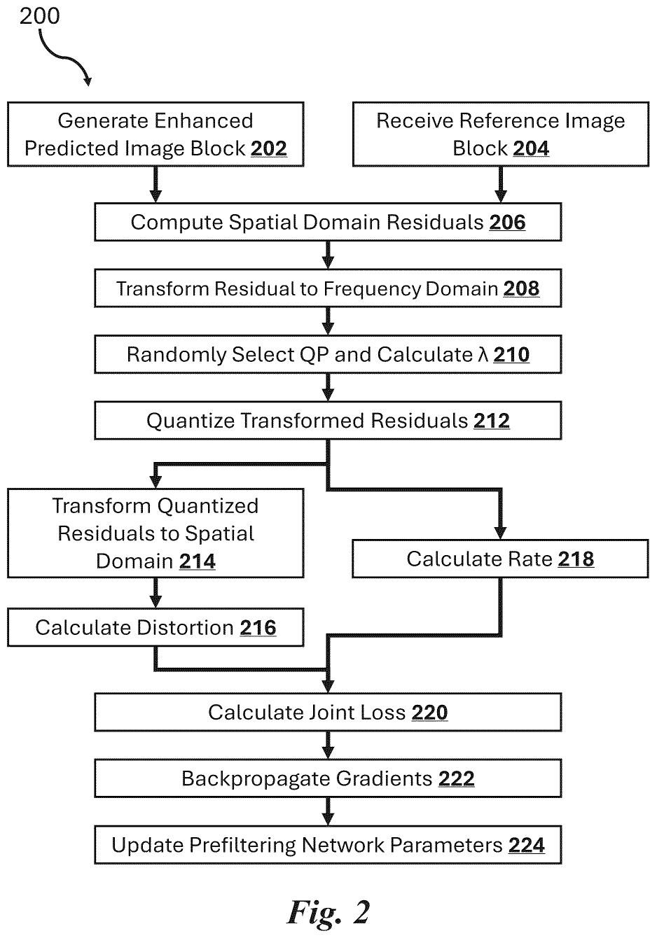

In the system 100, the predictor 102 includes both (i) off-the-shelf inter- and intra-predictors 102A and 102B and (ii) one or more learned prefilter networks (i.e., AI inter- and AI intra-predictors 102C and 102D). In various embodiments, a single learned prefilter network can function as both AI inter- and AI intra-predictors 102C and 102D or different learned prefilter networks can function as the AI inter- and AI intra-predictors 102C and 102D. The off-the-shelf inter- and intra-predictors 102A and 102B generate a plurality of traditional candidate predicted image blocks. The traditional candidate predicted image blocks are generated in accordance with any off-the-shelf video codec (e.g., H.264, H.265, HEVC, AV1, AV2, VVC, etc.) for compressing and decompressing digital video. The one or more learned prefilter networks (i.e., the AI inter- and AI intra-predictors 102C and 102D) receive the plurality of traditional candidate predicted image blocks and generate, for at least one (e.g., each) traditional candidate predicted image block, an AI-enhanced candidate predicted image block. The one or more learned prefilter networks (i.e., AI inter- and AI intra-predictors 102C and 102D) can be incorporated into an encoding pipeline of an off-the-shelf video without requiring any modification of the codec itself. Specifically, the one or more learned prefilter networks plug in to the processing pipeline of the off-the-shelf video codec and provide additional candidate predicted blocks to the RDO mode selector 104 of said codec. In certain embodiments, the one or more learned prefilter networks are trained via the process illustrated in FIG. 2.

The candidate predicted image blocks 103—which include both the traditional candidate predicted image blocks generated by off-the-shelf inter- and intra-predictors 102A and 102B and the AI-enhanced candidate predicted image blocks generated by AI inter- and AI intra-predictors 102C and 102D—are provided to the RDO mode selector 104. The RDO mode selector 104 selects, for each macroblock, a single predicted image block (predicted in accordance with a unique combination of prediction parameters) from the plurality of candidate image blocks 103. In at least one embodiment, the RDO mode selector 104 selects the single predicted image block for the macroblock via the process illustrated in FIG. 1C.

The corrector 106 computes, using the predicted image block selected by the RDO mode selector 104 and the corresponding macroblock of the frame of the input video 101, residuals (i.e., correction values) between the predicted image block and the corresponding macroblock. The corrector 106 outputs the computed residuals, which are provided as input to the residual encoder 108. The residual encoder 108 transforms the residuals into the frequency domain, quantizes the transformed residuals, and encodes the quantized transformed residuals into code stream 109. Code stream 109 can then be transmitted, via a network, to a user device and/or stored in memory. The code stream 109 includes, in addition to the quantized transformed residuals, an indication of a combination of prediction parameters (i.e., the prediction parameters in accordance with which the selected predicted image block is predicted) to enable a decoder to reconstruct the macroblock.

FIG. 1B illustrates example macroblock partition modes that can be included in the combination of prediction parameters in accordance with which a candidate predicted image block can be predicted. Partition modes 121 through 128 provide various combinations of horizontal splits, vertical splits, and further subdivision of image segments provided via horizontal and/or vertical splits. Partitioning a macroblock into smaller image segments enables different encoding strategies to be employed for different segments, thereby creating the possibility of enhancing compression performance. Different partition modes create different possibilities for enhancing compression performance for a given image, and the RDO mode selector can determine a candidate predicted image block that provides a partition mode that best enhances compression performance.

FIG. 1C is a flow diagram illustrating a process for selecting, by an RDO mode selector (e.g., RDO mode selector 104) for use in a downstream encoding process (e.g., the encoding process performed by the corrector 106 and the residual encoder 108), a single candidate predicted image block (e.g., one of candidate predicted image blocks 103) for a macroblock of a frame of an input video (e.g., a macroblock of a frame of input video 101). At 152, the process receives a plurality of candidate predicted image blocks that can be used for encoding a macroblock of a frame of an input video. Each of the plurality of candidate predicted image blocks has been predicted in accordance with a unique combination of prediction parameters, which can include—for example and without limitation—a prediction mode (i.e., intra-prediction or inter-prediction), a partition mode, a coding mode (e.g., I-frame, P-frame, or B-frame), a skip mode, a reference frame selection, a chroma subsampling mode, and a strength of one or more filters, e.g., a denoising filter, a sharpening filter, and/or a deblocking filter. At 152, the process also initializes the minimum value Jₘᵢₙ of a joint loss function J by setting Jₘᵢₙ equal to positive infinity.

At 154, the process selects a single candidate predicted image block of the plurality of candidate predicted image blocks received at 152. At 156, the process calculates the value of the joint loss function J for the selected candidate predicted image block. In at least one embodiment, the process calculates the value of the joint loss function J at 156 by (i) computing residuals (i.e., correction values) between the candidate predicted image block and the macroblock corresponding thereto, (iii) transforming the residuals into the frequency domain, (iv) quantizing the transformed residuals, and (v) encoding the quantized transformed residuals. The process then (vi) uses the encoded residuals to measure a distortion and a bit rate corresponding to the encoding of the selected candidate predicted image block and (vii) calculates the value of the joint loss function J. In at least one embodiment, the joint loss function J is computed according to J=D+λR, where D is a value of the distortion measure, R is a value of the bit rate measure, and λ is a weighting parameter that controls the relative magnitude of the distortion measure D and the bit rate measure R. Smaller values of the joint loss function J indicate better quality, because for a constant bit rate lower distortion and therefore lower J indicate better quality, or better compression, because for a constant distortion a lower bit rate and therefore lower J indicate a smaller file size/reduced network bandwidth.

At 158, the process compares the value of the joint loss function J computed for the selected candidate predicted image block to the stored value of Jₘᵢₙ. If the computed value of J is less than Jₘᵢₙ, then the process updates the value of Jₘᵢₙ at 160, stores an identifier of the selected candidate predicted image block as corresponding to the value of Jₘᵢₙ, and proceeds to 162. If the computed value of J is less than Jₘᵢₙ, then the process proceeds directly to 162. At 162, the process determines whether the candidate predicted image block selected at 154 was a last candidate predicted image block of the plurality of candidate image blocks received at 152. If the process determines, at 162, that additional candidate predicted image blocks remain, the process returns to 154, where an additional candidate predicted image block is selected. Alternatively, if the process determines, at 162, that all candidate predicted image blocks received at 152 have been processed, the process proceeds to 164. At 164, the process outputs the candidate predicted image block identified as corresponding to Jₘᵢₙ. In this manner, the process compares the compression results achieved with each of the plurality of candidate predicted image blocks and chooses the single candidate predicted image block that provides the best compression results for the downstream encoding process.

FIG. 2 is a flow diagram illustrating a process for training a prefiltering network with a joint loss function to enhance candidate predicted image blocks for improving compression during a downstream encoding process. The process illustrated in FIG. 2 trains the prefiltering network using a joint loss function that includes both (i) a distortion term and (ii) a bit rate term, enabling the prefiltering network to learn to balance the error from quantization (i.e., distortion) with improved bit rate.

At 202, an enhanced predicted image block is generated by a prefiltering network (e.g., a prefiltering network configured to serve as one or both of AI inter- and AI intra-predictors 102C and 102D of FIG. 1). The enhanced predicted image block is generated by transforming a candidate predicted image block, generated by a traditional inter- or intra-predictor (e.g., by one of off-the-shelf inter- and intra-predictors 102A and 102B) and corresponding to a reference image block of an input video (i.e., a reference macroblock), via the prefiltering network. At 204, the reference image block is received. At 206, spatial domain residuals are computed by comparing (i) the enhanced predicted image block generated at 202 and (ii) the reference image block received at 204.

At 208, the computed residuals are transformed to the frequency domain. In at least one embodiment, a discrete cosine transformation (DCT) is used to transform the residuals. However, alternative transformations may be used in other embodiments. At 210, a quantization parameter (QP) is randomly selected and the value of a weighting parameter (i.e., λ), which determines weighted contributions of rate and distortion to the joint loss function, is provided according to the randomly selected quantization parameter. Random selection of the quantization parameter ensures that, over a large number of training iterations, the prefiltering network learns to enhance predicted image blocks for low levels of compression, high levels of compression, and intermediate levels of compression. At 212, the transformed residuals are quantized in accordance with the randomly selected quantization parameter. In at least one embodiment, the transformed residuals (i.e., tensor T) are quantized according to

$$Q = round ( \frac{T}{QStep} ) ,$$

where Q is a tensor of the quantized residuals and QStep is a quantization step size (i.e., a constant scaling factor) obtained from a lookup table (that maps quantization parameters to quantization step sizes) based on the randomly selected quantization parameter. In at least one embodiment, the quantization parameters from the AV1 coded are used, providing a mapping of quantization parameters of [40, 255] to parameters of [4, 1828], and λ is determined by the selected quantization parameter. In at least one embodiment, the relationship between λ and the quantization parameter is provided by λ=e^{a*qp+b}, where a and b are hyperparameters borrowed from the HEVC codec (a=0.04651, b=−3.3953). In at least one embodiment, the quantization parameters and λ from the H.264 codec or from the H.265 codec are used.

At 214-216, the distortion component of the joint loss function is calculated. Specifically, at 214, an inverse transform (e.g., an inverse DCT) is applied to the quantized residuals provided at 212 to transform them to the spatial domain (thereby producing reconstructed residuals), and at 216, the reconstructed residuals are compared with the spatial domain residuals computed at 206 in order to calculate the value of the distortion term of the joint loss function. In at least one embodiment, the value of the distortion component is defined as the mean squared error (MSE) between the reconstructed residuals and the residuals computed at 206.

At 218, the rate component of the joint loss function is calculated. Specifically, the rate component is determined using a differentiable approximation of an entropy coding scheme used to compress the quantized residuals provided at 212. In at least one embodiment, the rate component is determined using a differentiable approximation of context-adaptive binary arithmetic coding (CABAC). However, in alternative embodiments, the rate component can be determined using a differentiable approximation of an alternative entropy coding technique. In at least one embodiment, the rate component is provided by the product of the quantized transformed residuals and an end-of-block (EOB) energy matrix. Since the scanning order is typically from top to bottom and left to right, ‘end-of-block’ typically refers to the bottom-right block, which has the highest energy. In at least one embodiment, Q is a tensor of the quantized residuals, E is the energy matrix (where grid x, grid_y=meshgrid(x, y, indexing=‘ij’) and E=grid_x**2+grid_y**2), the theoretical number of bits to transmit the quantized frequency Q is Qf=log(1+Q), and the rate component calculated at 218 is provided as R=Qf*E. The differentiable approximation uses the theoretical limit of the number of bits required to transmit the quantized residuals Q, thereby providing an accurate approximation of the number of bits required to transmit the quantized residuals provided at 212.

At 220, the joint loss is calculated using the joint loss function J=D+λR, wherein D is the distortion component determined at 216, R is the rate component determined at 218, and λ is the weighting parameter determined at 210. The training of the prefiltering network is performed with the objective of minimizing the value of the joint loss J. At 222, following the calculation of the joint loss J, gradients of the joint loss J are backpropagated to the prefiltering network, and learnable weights of the prefiltering network are updated based on gradients of the joint loss J with respect to the learnable weights. Because the quantization is a non-differentiable operation, gradient approximation is used during backpropagation to pass gradients computed for the quantized transformed residuals (e.g., ∇_{Q}J) to the transformed residuals, thereby allowing the gradient of the joint loss function J with respect to the transformed residuals (e.g., ∇_{T}J=f(∇_{Q}J)). In at least one embodiment, the gradient approximation is performed by using a straight-through estimator. While entropy coding is also a non-differentiable operation, the use of the differentiable approximation of the entropy coding scheme at 218 enables the gradient of the joint loss J with respect to the entropy coding to be computed and backpropagated, thereby facilitating training of the prefiltering network. At 224, the parameters of the prefiltering network are updated, based on the gradients, in order to satisfy the training objective, i.e., minimize the value of the joint loss function J. The process 200 is repeated for a desired number of training iterations.

As the learnable weights of the prefiltering network determine how a candidate predicted image block will be enhanced by the prefiltering network, the prefiltering network learns to enhance candidate predicted image blocks that can provide for improved compression during a downstream encoding process. For example, the prefiltering network can learn to enhance candidate predicted image blocks to reduce high-frequency details and noise in a manner that improves compression.

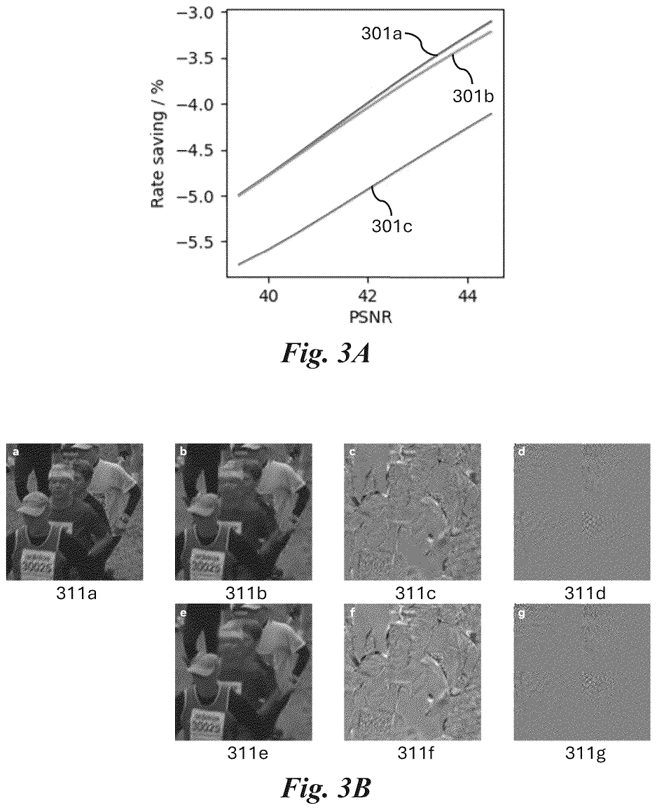

FIG. 3A is a graph of compression results achieved by incorporating, into an off-the-shelf video codec pipeline, a prefiltering network trained according to the process of FIG. 2 as compared to compression results achieved by incorporating prefiltering networks trained via alternative methods. FIG. 3A graphs the rate saving percentage versus image quality level (PSNR) for compression results achieved by incorporating a prefiltering network trained via the process of FIG. 2 (i.e., series 301c), a prefiltering network trained with an L1 loss (i.e., series 301a), and a prefiltering network trained with a DCT loss (i.e., series 301b). The x-axis shows the distortion between images compressed using AI-enhanced prefiltering networks and the ground truth images, and the y-axis shows a rate reduction percentage between images compressed using AI-enhanced prefiltering networks and images compressed without AI-enhanced prefiltering networks. The results indicate that a prefiltering network trained with DCT loss provides minimal improvement a prefiltering network trained with L1 loss, while a prefiltering network trained via the process of FIG. 2 provides a significant additional 0.5%-bit reduction across various quality levels.

FIG. 3B provides example predicted candidate image blocks and residuals corresponding to an example reference image block. 311a is a ground truth macroblock, 311b is a candidate predicted image block provided by a traditional, off-the-shelf predictor, 311c is a residual map for the candidate predicted image block 311b in the spatial domain, and 311d is a residual map for the candidate predicted image block 311b in the frequency domain. 311e is an AI-enhanced candidate predicted image block provided by an AI-enhanced predictor (e.g., a prefilter network trained via the process of FIG. 2), 311f is a residual map for the candidate predicted image block 311e in the spatial domain, and 311g is a residual map for the candidate predicted image block 311e in the frequency domain. In 311d and 311g, the residual map in the frequency domain is transformed using a DCT II transform and quantized using a 16×16 subsample partition mode.

Example architectures via which foregoing systems methods may be implemented, per the desires of the user, are provided herein below. It should be strongly noted that the following information is set forth for illustrative purposes and should not be construed as limiting in any manner. Any of the following features may be optionally incorporated with or without the exclusion of other features.

### Parallel Processing Architecture

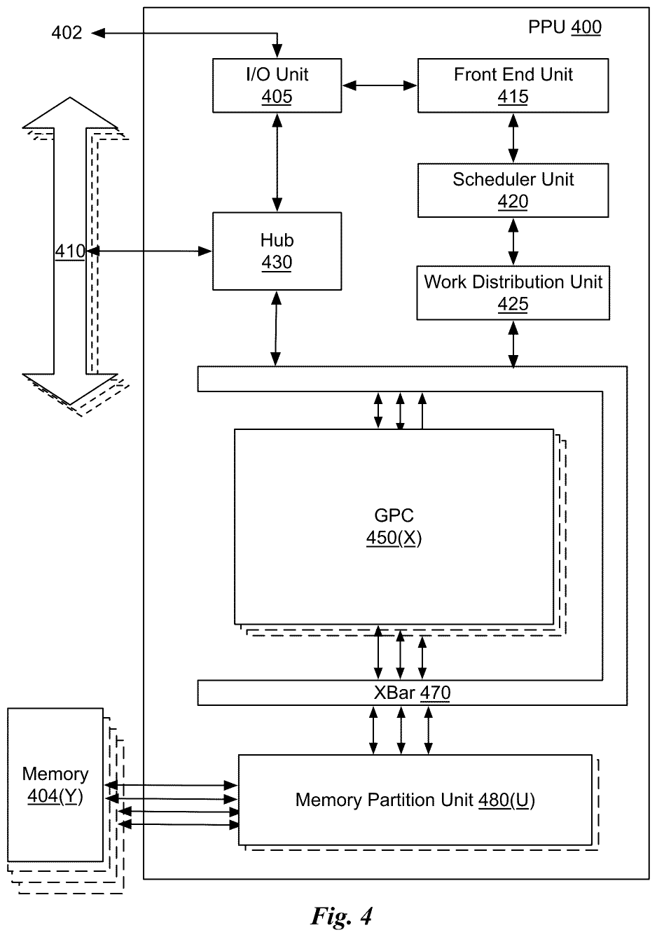

FIG. 4 illustrates a parallel processing unit (PPU) 400, in accordance with an embodiment. In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

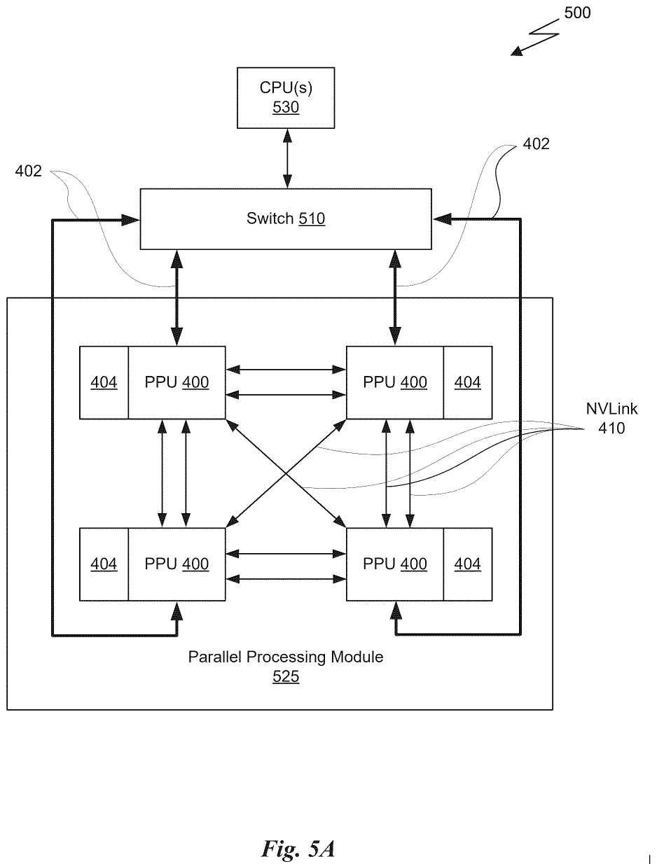

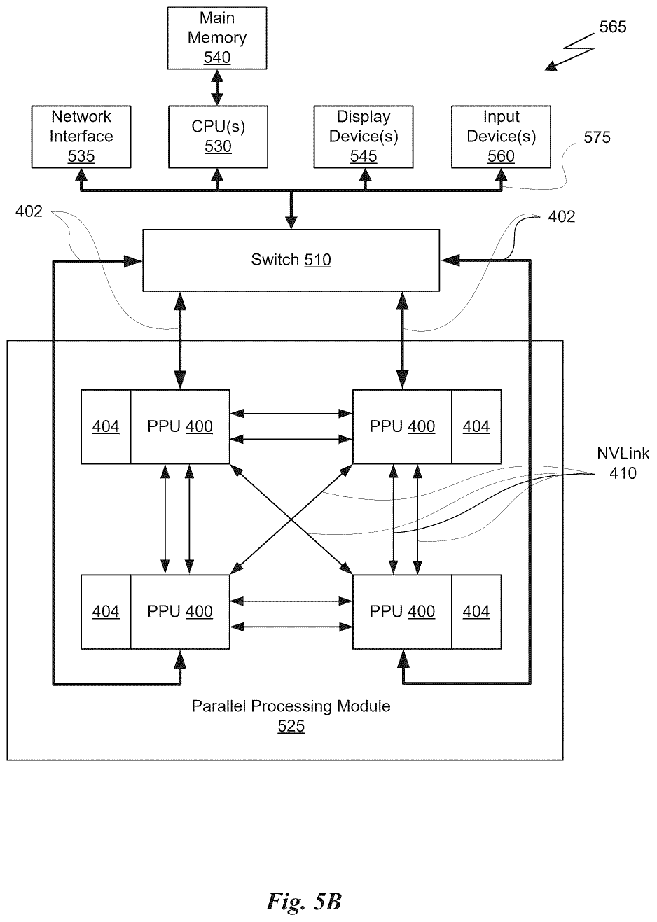

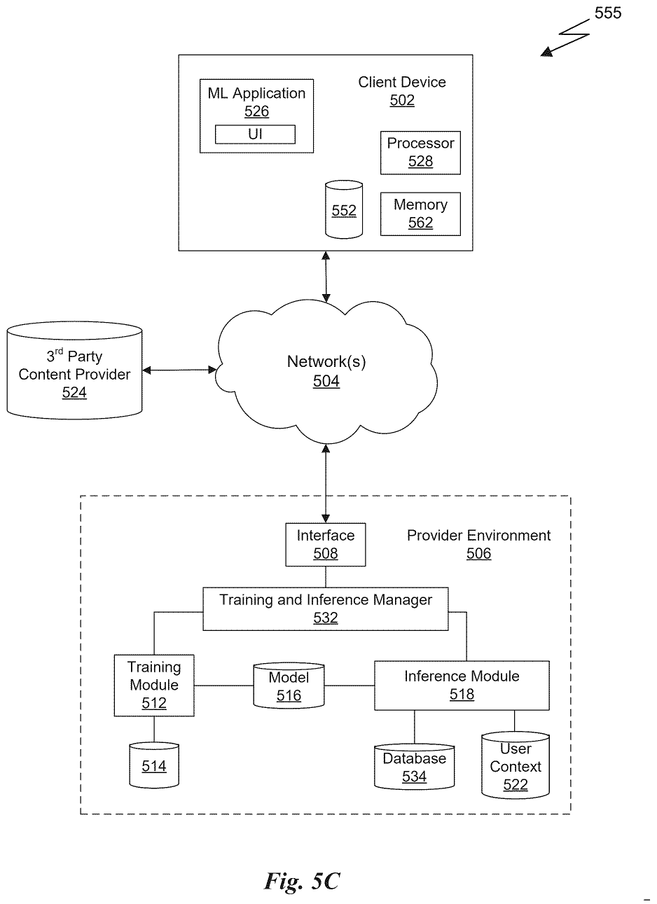

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in the L2 cache 460, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache 460 is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5C are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5C is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5C.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5B and/or exemplary system 565 of FIG. 5C. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 300 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In an embodiment, the set of training data may be used in a generative adversarial training configuration to train a generator neural network.

In at least one embodiment, training data can include images of at least one human subject, avatar, or character for which a neural network is to be trained. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Example Streaming System

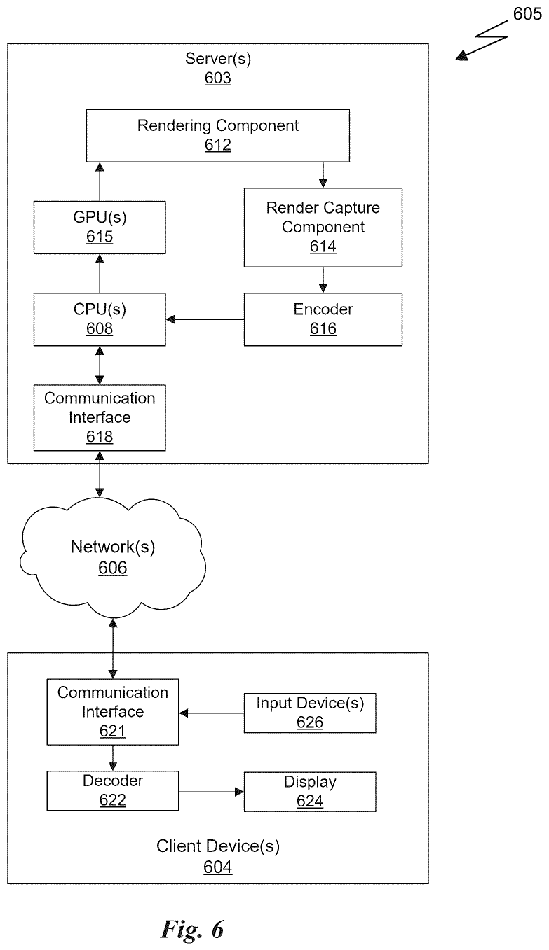

FIG. 6 is an example system diagram for a streaming system 605, in accordance with some embodiments of the present disclosure. FIG. 6 includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s), transmit the input data to the game server(s) 603, receive encoded display data from the game server(s) 603, and display the display data on the display 624. As such, the more computationally intense computing and processing is offloaded to the game server(s) 603 (e.g., rendering—in particular ray or path tracing—for graphical output of the game session is executed by the GPU(s) of the game server(s) 603). In other words, the game session is streamed to the client device(s) 604 from the game server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the game server(s) 603. The client device 604 may receive an input to one of the input device(s) and generate input data in response. The client device 604 may transmit the input data to the game server(s) 603 via the communication interface 621 and over the network(s) 606 (e.g., the Internet), and the game server(s) 603 may receive the input data via the communication interface 618. The CPU(s) may receive the input data, process the input data, and transmit data to the GPU(s) that causes the GPU(s) to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the game server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A method for compressing a video, the method comprising:
generating, for a reference block of a frame of the video, a plurality of candidate predicted blocks, at least one of the plurality of candidate predicted blocks being predicted in accordance with one or more prediction parameters;
enhancing, by at least one prefiltering network trained to minimize a joint loss function that includes a distortion component and a rate component, the plurality of candidate predicted blocks to provide a plurality of enhanced candidate predicted blocks;
selecting a predicted block from the plurality of candidate predicted blocks and the plurality of enhanced candidate predicted blocks;
computing, using the selected predicted block and the reference block, residuals; and
encoding the residuals in a codestream.

2. The method according to claim 1, wherein the rate component of the joint loss function is determined using a differentiable approximation of an entropy coding scheme.

3. The method according to claim 2, wherein the entropy coding scheme is context-adaptive binary arithmetic coding (CABAC), and wherein the differentiable approximation is a theoretical limit of a number of bit Qf=log(1+Q) required to transmit quantized residuals Q using the entropy coding scheme.

4. The method according to claim 1, wherein the distortion component of the joint loss function is determined, during at least one training iteration, by comparing (i) one or more spatial domain residuals reconstructed from quantized residuals computed from an enhanced predicted training block and a reference training block and (ii) one or more spatial domain ground-truth residuals computed from the enhanced predicted training block and the reference training block.

5. The method according to claim 4, wherein the distortion component of the joint loss function is the mean squared error (MSE) between the one or more reconstructed residuals and the one or more ground-truth residuals.

6. The method according to claim 1, wherein the at least one prefiltering network is a prefiltering network, one or more parameters of the at least one prefiltering network being updated to minimize the joint loss function via a process that comprises a plurality of training iterations, and wherein a quantization parameter is randomly selected for at least one training iteration of the plurality of training iterations.

7. The method according to claim 1, wherein the at least one prefiltering network is a prefiltering network, one or more parameters of the at least one prefiltering network being updated to minimize the joint loss function via a training process that comprises a plurality of training iterations, at least one training iteration of the plurality of training iterations comprising:
enhancing a predicted training block;
computing, using the enhanced predicted training block and a reference training block, one or more training residuals;
quantizing the one or more training residuals;
calculating, based on the one or more quantized training residuals, a value of the joint loss function from a value of the distortion component and a value of the rate component;
computing, based on the calculated value of the joint loss function, one or more gradients of the joint loss function with respect to one or more parameters of the prefiltering network; and
updating the one or more parameters of the prefiltering network based on the computed gradients.

8. The method according to claim 1, wherein the plurality of candidate predicted blocks are generated by an intra-frame predictor and an inter-frame predictor; and
wherein the at least one prefiltering network comprises:
an intra-frame prefiltering network for enhancing candidate predicted blocks generated by the intra-frame predictor and an inter-frame prefiltering network for enhancing candidate predicted blocks generated by the inter-frame predictor, or
a single prefiltering network for enhancing candidate predicted blocks generated by the intra-frame predictor and candidate predicted blocks generated by the inter-frame predictor.

9. The method according to claim 1, wherein the combination of prediction parameters include one or more parameters specifying at least one of: a prediction mode, a partition mode, a coding mode, a skip mode, a reference frame selection, a chroma subsampling mode, or a strength of one or more filters.

10. A system for compressing a video, the system comprising:
processing circuitry configured to:
generate, for a reference block of a frame of the video, a plurality of candidate predicted blocks, at least one of the plurality of candidate predicted blocks being predicted in accordance with a combination of prediction parameters,
apply, to at least one prefiltering network, the plurality of candidate predicted blocks to provide a plurality of enhanced candidate predicted blocks,
select a predicted block from the plurality of candidate predicted blocks and the plurality of enhanced candidate predicted blocks,
compute, using the selected predicted block and the reference block, residuals, and
encode the residuals in a codestream; and
memory configured to store the reference block, the plurality of candidate predicted blocks, and the codestream.

11. The system according to claim 10, wherein the rate component of the joint loss function is determined using a differentiable approximation of an entropy coding scheme.

12. The system according to claim 11, wherein the entropy coding scheme is context-adaptive binary arithmetic coding (CABAC), and wherein the differentiable approximation is a theoretical limit of a number of bits Qf=log(1+Q) required to transmit quantized residuals Q using the entropy coding scheme.

13. The system according to claim 10, wherein the distortion component of the joint loss function is determined, during at least one of a plurality of training iterations, by comparing (i) one or more spatial domain residuals reconstructed from one or more quantized residuals computed using an enhanced predicted training block and a reference training block, with (ii) one or more spatial domain ground-truth residuals computed using the enhanced predicted training block and the reference training block.

14. The system according to claim 13, wherein the distortion component of the joint loss function is the mean squared error (MSE) between the reconstructed residuals and the ground-truth residuals.

15. The system according to claim 10, wherein the at least one prefiltering network is a prefiltering network trained to minimize the joint loss function via a training process that comprises a plurality of training iterations, and wherein a quantization parameter is randomly selected for at least one training iteration of the plurality of training iterations.

16. The system according to claim 10, wherein the at least one prefiltering network is a prefiltering network trained to minimize the joint loss function via a training process that comprises a plurality of training iterations, at least one training iteration comprising:
enhancing a predicted training block;
computing, using the enhanced predicted training block and a reference training block, one or more training residuals;
quantizing the one or more training residuals;
calculating, based on the one or more quantized training residuals, a value of the joint loss function from a value of the distortion component and a value of the rate component;
computing, based on the calculated value of the joint loss function, one or more gradients of the joint loss function with respect to one or more parameters of the prefiltering network; and
updating the parameters of the prefiltering network based on the computed gradients.

17. The system according to claim 10, wherein the processing circuitry comprises an intra-frame predictor and an inter-frame predictor for generating the plurality of candidate predicted blocks; and
wherein the at least one prefiltering network comprises:
an intra-frame prefiltering network for enhancing candidate predicted blocks generated by the intra-frame predictor and an inter-frame prefiltering network for enhancing candidate predicted blocks generated by the inter-frame predictor, or
a single prefiltering network for enhancing candidate predicted blocks generated by the intra-frame predictor and candidate predicted blocks generated by the inter-frame predictor.

18. The system according to claim 10, wherein the combination of prediction parameters include one or more parameters specifying at least one of: a prediction mode, a partition mode, a coding mode, a skip mode, a reference frame selection, a chroma subsampling mode, or a strength of one or more filters.

19. A system comprising:
one or more processing units to generate, for a reference block of a frame of the video, a plurality of candidate predicted blocks and, using a neural network, a plurality of enhanced candidate predicted blocks, wherein one or more residuals are computed using the reference block and a selected predicted block selected from the plurality of candidate predicted blocks and the plurality of enhanced candidate predicted blocks.

20. The system of claim 19, wherein the one or more processing units are included in a system comprising at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations;
a system implemented using one or more large language model (LLMs),
a system implemented using one or more vision language model (VLMs);
a collaborative content creation platform for 3D assets; or
a system implemented at least partially using cloud computing resources.
